(19) United States
(12) Patent Application Publication
(10) Pub. No.: US 2005/0230460 A1
(43) Pub. Date: Oct. 20, 2005

(54) Mailer with three-dimensional attributes

(75) Inventor: Melvin H. Ristau, Ft. Collins, CO (US)

Correspondence Address: David Allen Hall;Jackson Walker L.L.P., Suite 2100, 112 E. Pecan Street, San Antonio, TX, 78205-1521, US

(73) Assignee: MediaGarden, Inc.

(21) Appl. No.: 11/105,108

(22) Filed: Apr. 13, 2005

Related U.S. Application Data
(60) Provisional application No. 60/562,415, filed on Apr. 15, 2004.

(51) Int. Cl. B42D 15/00

(52) U.S. Cl. 229/92.8

(57) ABSTRACT

A postal mailer that, while being thin enough to comply with postal size regulations, opens into a three dimensional graphic object capable of conveying to the recipients clear or subtle messages in the form of flat or nearly flat objects such as notes, letters, pictures, gift cards, tickets, cash, and drawings. The three-dimensional graphic object is more attractive than typical mailers, and becomes a memorable, integral part of the message.

This patent claims priority from and incorporates by reference the provisional U.S. Patent Application Ser. No. 60/562,415, filed Apr. 15, 2004.

### BACKGROUND OF THE INVENTION

The present invention pertains to the field of print communication, including, but not limited to, postal mailers, greeting cards, personal letters, and mass advertising mailings. U.S. Pat. No. 6,679,032 B2 (Gerrie, 2004), U.S. Pat. No. 6,615,516 B1 (Houston, 2003), and U.S. Pat. No. 6,434,867 (Ristau, 2002) disclose various mailers. Gerrie discloses a mailer that may contain drawings and/or a greeting card message in a two-dimensional packet that unfolds into a two-dimensional display having a turned-out tab that serves as an easel support. Houston discloses a two dimensional mailer that holds a two-dimensional graphic comprised of multiple pieces that fit together like a jig-saw puzzle. Ristau discloses a two-dimensional mailer that holds a two-dimensional one-piece graphic that may house a message or advertisement. None of the cited patents disclose or claim the present invention apparatus.

Because the typical greeting card or postal mailer is two dimensional, its message lacks the memorialization that senders hope for. Friends, lovers, relatives, and advertisers would like to give and send communications that, rather than being discarded immediately or shortly after receipt, would capture the recipient's attention sufficiently to motivate him or her to keep the communication, display it, share it with others, and remember or heed its message.

### BRIEF DESCRIPTION OF THE DRAWINGS

FIG. 1 is a drawing of one embodiment of the present invention in its substantially flat configuration.

FIG. 2 is a drawing of the embodiment of FIG. 1 with a centrally located packet unfolded into a three-dimensional configuration to expose a small note sheet that can be pulled from the packet.

FIG. 3 is a drawing of another embodiment of the present invention in which gift cards and notes are contained in a packet attached to a flat graphic object.

FIG. 4 is a drawing of the embodiment of FIG. 3 with its centrally located packet opened to expose several gift cards and notes that can be pulled from the packet.

FIG. 5 is a drawing of another embodiment of the present invention in its substantially flat configuration.

FIG. 6 is a drawing of the FIG. 5 embodiment unfolded into a three-dimensional caricature configuration, part of which is a centrally located packet containing a small accessible note sheet.

### DETAILED DESCRIPTION OF THE PREFERRED EMBODIMENT

Herein the terms “mailer” and “postal mailer” will be used to denote a tangible form of printed communication that is capable of carrying attached postage (stamps or metering) and being mailed under the regulations of the US Postal Service, but is also capable of being delivered by hand or any other method not necessarily requiring attached postage. Herein the term “packet” will be used to denote an envelope, bag, pouch, box, canister, or any other container. In any embodiment of the present invention calling for a packet, the mailer of which the packet is a part must comply with US Postal Service regulations.

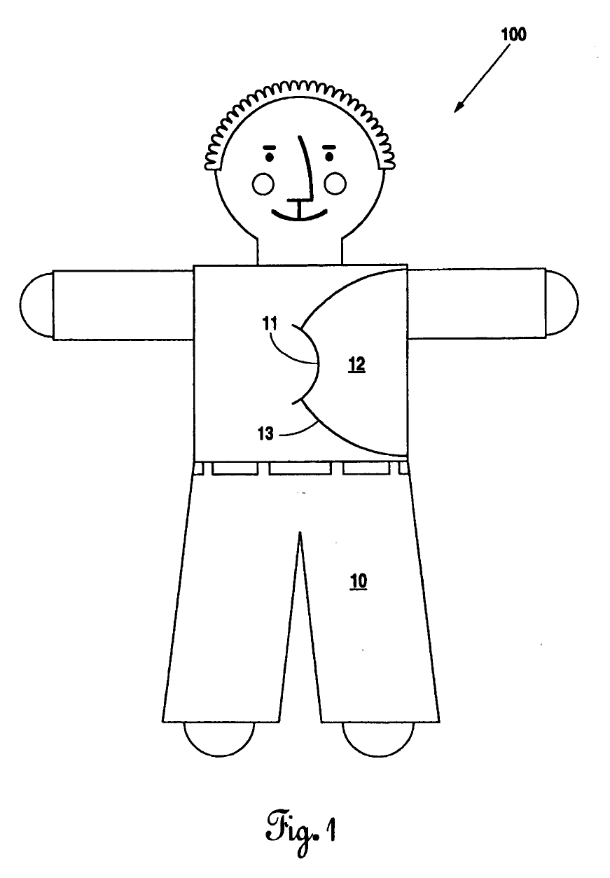

One embodiment of the present invention can be constructed from heavy paper. FIG. 1 illustrates the paper die cutting, from a single sheet of paper, of the caricature 100 of a boy. Various areas of the boy and his clothing are screen-printed with different colors. For example, the pants 10 of the caricature 100 are a color different from that of the shirt 12. On the front of shirt 12 is a flap 13 that tucks into a slot 11.

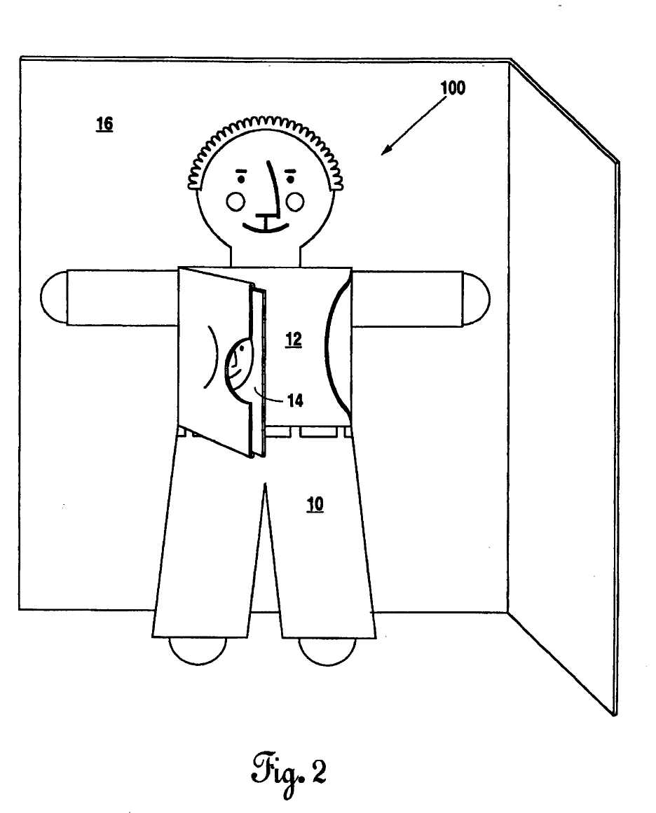

FIG. 2 shows that upon receipt of the mailer, the shirt 12 can be opened by the recipient. The part of shirt 12 that opens is a packet made of a sheet of heavy paper that is cut and folded so as to provide a hollow compartment glued to the upper torso area of caricature 100. In its initial, or mailing configuration, the packet is folded flat to form part of shirt 12, as illustrated in FIG. 1.

FIG. 2 shows that inside the packet section of shirt 12 is a separate sheet of paper 14 on which is inscribed a message. Caricature 100 is shown leaning against the envelope 16 in which it can be mailed. Alternatively, caricature 100 can be attached to a single sheet capable of having postage and the recipient's address attached. Alternatively, postage and the recipient's address can be attached directly to caricature 100. Alternatively, caricature 100 can be given directly to someone without being mailed.

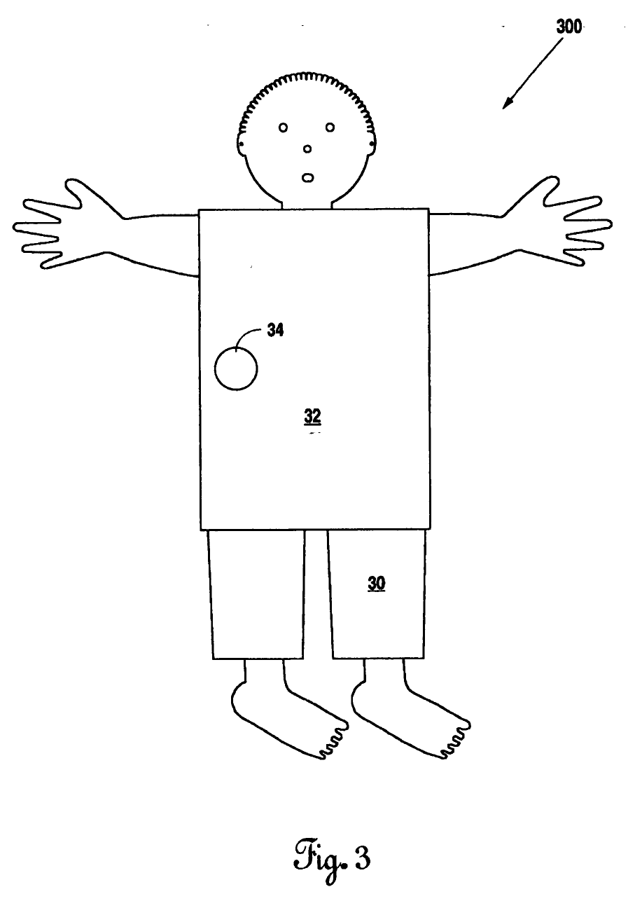

FIG. 3 shows an embodiment of the present invention in which the die cutting of a caricature 300 of a boy is made from foam. Translucent plastic packet 32, a readily available item, is attached to foam die cutting 30 with adhesive or other commonly understood means of attachment, and can be snapped shut with snap 34.

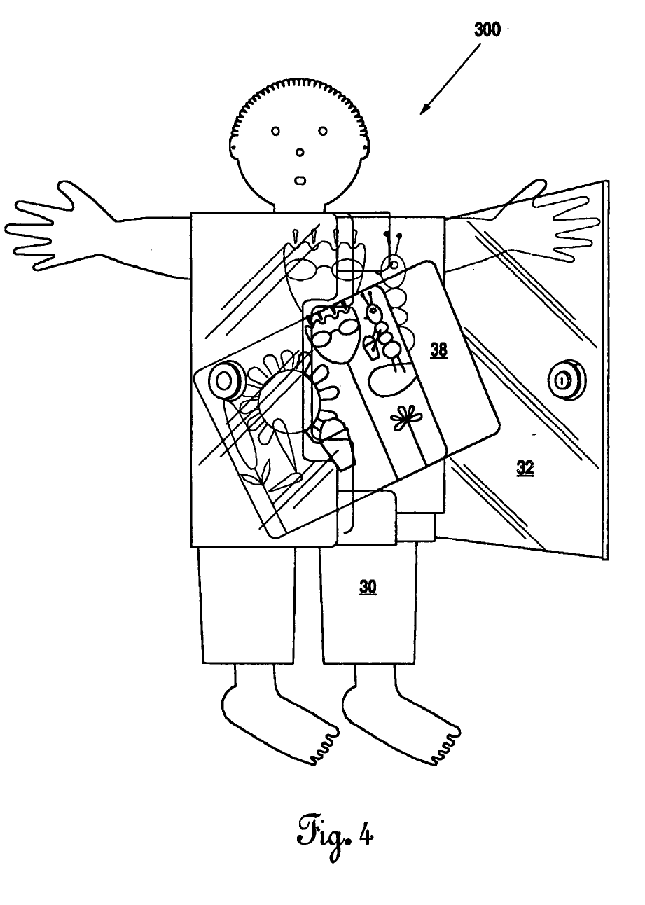

When opened, packet 32 is seen in FIG. 4 to contain gift cards and notes 38. Caricature 300 can be mailed in an envelope or attached to a single sheet capable of having postage and the recipient's address attached. Alternatively, postage and the recipient's address can be attached directly to caricature 300. Alternatively, caricature 300 can be given directly to someone without being mailed.

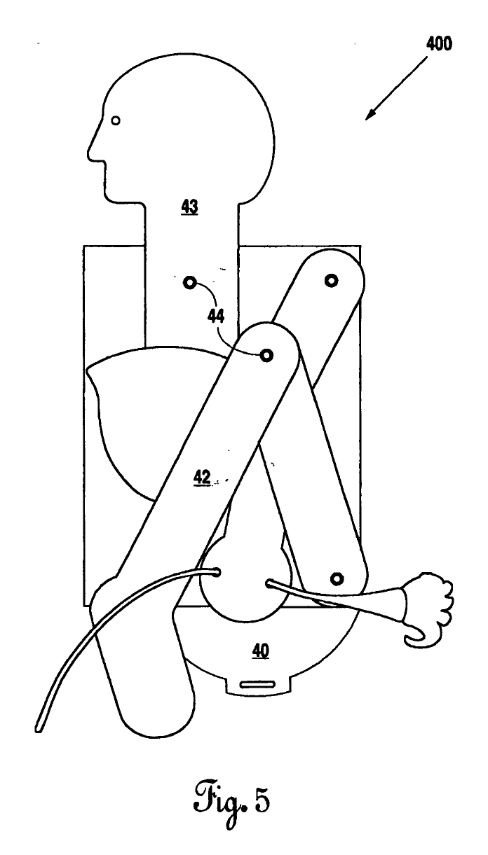

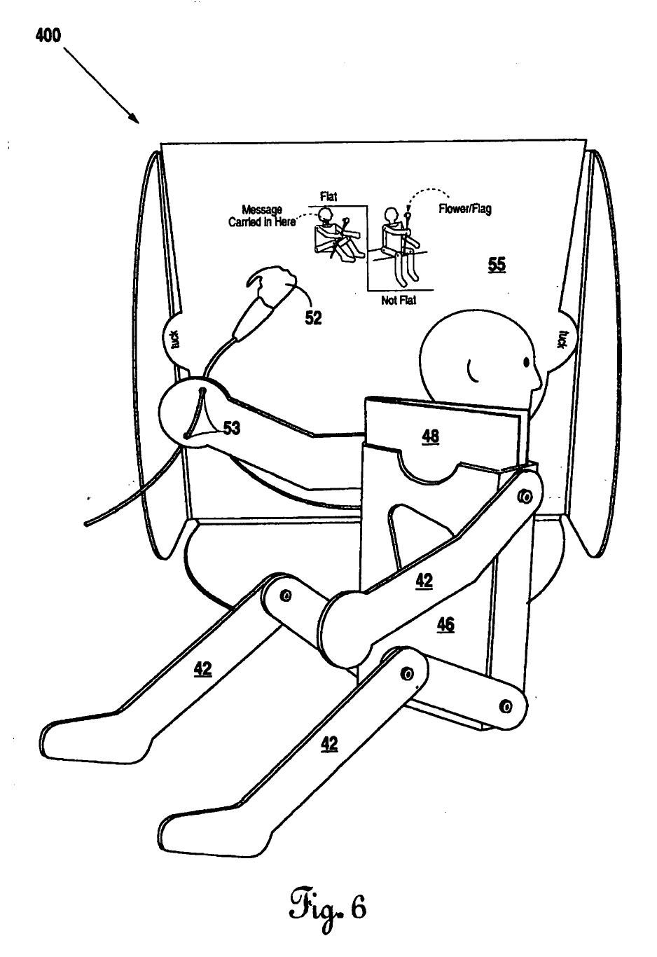

FIG. 5 shows an embodiment of the present invention in which caricature 400 is made of die cut posterboard limb sections 42 and head section 43 rotateably attached with rivets 44 to die cut posterboard chest section 46 (shown in FIG. 6). Section 40 is a bottom flap that is a part of section 46. It tucks into a slot cut into section 46 and maintains rigidity of section 46 when section 46 is opened as in FIG. 6. FIG. 5 shows caricature 400 in its mailing configuration with all sections 42 rotated to achieve the minimum profile and perimeter. Head section 43 has a male head and a female head on opposite ends, and can be pivoted 360 degrees about rivet 44 located midway between the two heads. Instead of two heads, the head section 43 could be made with a single head so that rotation could further decrease the caricature 400 perimeter.

FIG. 6 shows the embodiment of FIG. 5 with sections 42 rotated to result in the three-dimensional caricature 400 holding a flower 52. FIG. 6 also shows chest section 46 opened to reveal an enclosed note 48 that may be pulled out by the mailer recipient. Any number of decorative or meaningful objects can be attached to any of the limb sections 42 or head section 43, and any number of substantially flat objects can be carried in chest section 46. FIG. 6 shows a flower 52 with its stem threaded through two holes 53 punched near the extremity of one limb section 42. Caricature 400 is shown seated in front of the envelope 55 in which it can be mailed. In the FIG. 6 embodiment, directions for unfolding caricature 400 are printed on envelope 55.

It will be apparent to those with ordinary skill in the relevant art having the benefit of this disclosure that the present invention provides a mailer with three-dimensional attributes. It is understood that the forms of the invention shown and described in the detailed description and the drawings are to be taken merely as presently preferred examples and that the invention is limited only by the language of the claims. While the present invention has been described in terms of one preferred embodiment and a few variations thereof, it will be apparent to those skilled in the art that form and detail modifications may be made to those embodiments without departing from the spirit or scope of the invention.

For example, all the present invention mailers can be constructed of paper, cardboard, poster board, foam, plastic, petroleum derivative, vinyl, elastomer, metal foil, ribbon, cloth, wood, wood derivative, leather, fur, or any material that can be produced in sections thin enough or flexible enough to fabricate mailers. The present invention mailers do not have to be rigid; they can be malleable, as long as they comply with postal sizing regulations. Text and artwork can be applied to any of the components of embodiments of the present invention using screen printing, conventional printing, digital printing, appliques, cut foam, or any methods used by artists such as water-color, oil, or acrylic paint.

Also, portions of the present invention that are described above as die cuttings can be laser cut, saw cut, stamped, punched, milled, molded, carved, extruded, sintered, or manufactured in any manner compatible with sections thin enough for fabrication of mailers that comply with postal sizing regulations.

1. A mailer comprising a graphic display having one or more cooperating members, one or more of said cooperating members having a substantially three-dimensional hollow configuration capable of exposing for extraction one or more captured objects.

2. A mailer as in claim 1 wherein said cooperating member having a substantially three-dimensional configuration achieves said substantially three-dimensional configuration by unfolding from a substantially flat configuration.

3. A mailer as in claim 1 wherein two or more of said cooperating members are rotateably joined.
